(19) United States
(12) Patent Application Publication
(10) Pub. No.: US 2014/0319429 A1
(43) Pub. Date: Oct. 30, 2014

(54) METHOD FOR PREPARING A PASTE-LIKE COMPOSITION COMPRISING CARBON-BASED CONDUCTIVE FILLERS

(71) Applicant: Arkema France, Colombes (FR)

(72) Inventors: Serge Nicolas, Lons (FR); Alexander Korzhenko, Pau (FR); Amélie Merceron, Aussevielle (FR); Yvan Lecomte, Arthez de Bearn (FR)

(21) Appl. No.: 14/359,159

(22) PCT Filed: Nov. 19, 2012
(86) PCT No.: PCT/FR2012/052665

§ 371 Date: May 19, 2014

(30) Foreign Application Priority Data
Nov. 18, 2011 (FR) 1160515

(51) Int. Cl. H01B 1/24

(52) U.S. Cl. CPC H01B 1/24
USPC 252/511

(57) ABSTRACT

A method for preparing a paste-like composition including carbon-based conductive fillers, at least one polymeric binder, at least one solvent, and at least one polymeric dispersant being different from the binder. Also, the paste that can result from said method, and to the uses thereof, in pure or diluted form, in particular for the manufacture of Li-ion batteries and supercapacitors.

### FIELD OF THE INVENTION

The present invention relates to a process for the preparation of a pasty composition including carbon-based conductive fillers, at least one polymeric binder, at least one solvent and at least one polymeric dispersant distinct from the binder. It also relates to the paste capable of being thus obtained and to its uses, in particular in the manufacture of electrodes of Li-ion batteries and supercapacitors.

### BACKGROUND OF THE INVENTION

An Li-ion battery comprises at least one negative electrode or anode coupled to a current collector made of copper, a positive electrode or cathode coupled to a current collector made of aluminum, a separator and an electrolyte. The electrolyte is composed of a lithium salt, generally lithium hexafluorophosphate, mixed with a solvent which is a mixture of organic carbonates which are chosen in order to optimize the transportation and the dissociation of the ions. A high dielectric constant promotes the dissociation of the ions and thus the number of ions available in a given volume, whereas a low viscosity promotes ion diffusion, which plays an essential role, among other parameters, in the charge and discharge rates of the electrochemical system.

For their part, the electrodes generally comprise at least one current collector on which is deposited a composite material which is composed of: an “active” material, as it exhibits an electrochemical activity with regard to lithium, a polymer, which acts as binder and which is generally a vinylidene fluoride copolymer for the positive electrode and aqueous-based binders, of carboxymethylcellulose type, or styrene-butadiene latexes for the negative electrode, plus an additive which conducts electrons, which is generally carbon black Super P or acetylene black, and optionally a surfactant.

During charging, lithium is inserted into the active material of the negative electrode (anode) and its concentration is kept constant in the solvent by the extraction of an equivalent amount of the active material of the positive electrode (cathode). The insertion into the negative electrode is reflected by a reduction of the lithium and it is therefore necessary to contribute, via an external circuit, the electrons to this electrode originating from the positive electrode. At discharge, the reverse reactions take place.

It has been demonstrated in previous studies that the fact of replacing the carbon black or the acetylene black with carbon nanotubes (CNTs) or also of adding CNTs to such conductive additives exhibits numerous advantages: increase in the electrical conductivity, better incorporation around the particles of active material, good intrinsic mechanical properties, ability to form an electrical network better connected in the body of the electrode and between the metal collector and the active material, good maintenance of the capacity in cycling in the electrode composite material, and the like.

The introduction of the CNTs into the formulations of the materials constituting the electrodes all the same still exhibits a few disadvantages which have to be overcome.

Thus, when the dispersion of the CNTs is produced directly in the liquid formulations (in particular in the organic solvent bases), the dispersion strongly viscosifies and such a dispersion has a low stability. In order to overcome this disadvantage, recourse is had to bead mixers, grinders and high-shear mixers. However, the content of CNTs capable of being introduced into the liquid formulations remains restricted to 1-2%. These difficulties put a break on the practical use of CNTs in the formulations of the materials constituting the electrodes due to the aggregation of the CNTs as a result of their highly entangled structure.

In addition, from a toxicological viewpoint, CNTs are generally provided in the form of agglomerated powder grains, the mean dimensions of which are of the order of a few tens of microns. The differences in dimensions, in shape and in physical properties mean that the toxicological properties of the CNT powders are not yet fully known. It is the same for other carbon-based conductive fillers, such as carbon black or carbon nanofibers. It would thus be preferable to be able to work with carbon-based conductive fillers in a form which can be more easily handled.

In this regard, the document US 2004/0160156 describes a method for the preparation of a battery electrode from a masterbatch, in the form of granules composed of CNT and of a resin acting as binder, to which a suspension of electrode active material is added.

In this document, the resin is present in a large amount within the masterbatch, since the CNTs are present in proportions ranging from 5 to 20 parts by weight per 100 parts by weight of resin. This high content of binder is problematic for the formulator of electrode materials who wishes to use “universal” masterbatches in predefined compositions without bringing about formulation constraints, in particular without limiting the choice of the binder used in these compositions. In addition, the presence of a large amount of binder in the formulation of the electrically conductive ink decreases the proportion of electrode active material which can be used and thus the overall capacity of the battery.

In order to overcome these problems, the applicant company has provided a masterbatch in agglomerated solid form comprising: from 15% to 40% by weight of CNTs, at least one solvent and from 1% to 40% by weight of at least one polymer binder (WO 2011/117530). Furthermore, the document EP 2 081 244 describes a liquid dispersion based on CNT, on a solvent and on a binder which is intended to be sprayed over a layer of electrode active material.

However, it is apparent to the applicant company that the solutions provided in these documents are still imperfect, in the sense that they do not make it possible to always avoid the persistence of CNT aggregates in these compositions, so that a fraction of the CNTs is not optimally used to improve the electrical conductivity of the electrode obtained from these compositions.

For its part, the document US 2011/171364 suggests another solution for reducing the amount of binder in electrically conductive ink formulations. It describes a paste based on CNT agglomerates mixed with a dispersant, such as poly(vinylpyrrolidone) or PVP, with an aqueous or organic solvent and optionally with a binder, the presence of which is optional. The process for the manufacture of this paste comprises a stage, presented as crucial, of grinding (or subjecting to ultrasound) in tangled masses of CNT, having a mean diameter of approximately 100 μm, produced according to a process of catalytic decomposition of hydrocarbons in the fluidized bed. This stage makes it possible to obtain CNT agglomerates having a size of less than 10 μm in at least one dimension, that is to say a degree of dispersion, on the Hegman scale, of greater than 7. The grinding can be carried out before or after mixing the CNTs with the dispersant, the solvent and the optional binder. A paste of this type is commercially available in particular from C Nano, under the trade name LB® 100.

The solution provided in this document exhibits the disadvantage of using a manufacturing process comprising a stage of grinding, preferably by pulverization, which is capable of exhibiting risks of environmental pollution, indeed even health risks. In addition, the paste obtained has a viscosity of at least 5000 cPs, which can cause difficulties of dispersion in some cases.

The document US 2011/0171371 describes the preparation of a Li-ion battery electrode comprising a composition based on carbon nanotubes. The performance of the electrode is improved by increasing the content of electrode active material, while reducing the content of binder present in the composition. To this end, in order to facilitate the dispersion of the carbon nanotubes in the composition having a low content of binder, this document recommends reducing the size of the CNT agglomerates, in particular using a jet mill

It remains desirable to be able to have available a process for the manufacture of a paste based on carbon-based conductive fillers, in particular on CNT, which is simple to carry out and more environmentally friendly than the process described in US 2011/171364. The need also remains to have available a paste based on such fillers, in which the latter are dispersed efficiently and in a stable manner, that is to say that phase separation between the solvent and the solid part of the paste does not occur over time, said paste furthermore exhibiting a viscosity which is sufficiently low to be able to be easily dispersed in various solvents and polymer matrices, regardless of the mixer used and the mixing conditions employed.

### SUMMARY OF THE INVENTION

This need is met, according to the present invention, by the use of a kneading device to prepare the composition including carbon-based conductive fillers, a solvent and a binder and by the use of a dispersant, such as PVP, in this composition.

The present invention relates specifically, according to a first aspect, to a process for the preparation of a pasty composition based on carbon-based conductive fillers, comprising:
(i) the introduction into a kneader, and then the kneading, of carbon-based conductive fillers, of at least one polymeric binder, of at least one solvent and of at least one polymeric dispersant distinct from said binder, chosen from poly(vinylpyrrolidone), poly(phenylacetylene), poly(meta-phenylene vinylidene), polypyrrole, poly(para-phenylene benzobisoxazole), poly(vinyl alcohol) and their mixtures, in order to form a masterbatch comprising a proportion by weight of 15% to 40% of carbon-based conductive fillers and of 20% to 85% of solvent and in which the ratio by weight of the polymeric binder to the carbon-based conductive fillers is between 0.04 and 0.4 and the ratio by weight of the polymeric dispersant to the carbon-based conductive fillers is between 0.1 and 1, limits included;
(ii) the extrusion of said masterbatch in a solid form;
(iii) the diluting of said masterbatch in a solvent which is identical to or different from that of stage (i), in order to obtain a pasty composition.

The invention also relates, according to a second aspect, to the pasty composition capable of being obtained according to this process.

In addition, it relates, according to a third aspect, to the use of said pasty composition in the preparation of thin conductive films, conductive inks or conductive coatings, in particular in the manufacture of electrodes of Li-ion batteries or of supercapacitors, or in the preparation of conductive composite materials.

The process according to the present invention makes it possible to render the carbon-based conductive fillers easy to handle for liquid-phase applications by efficiently dispersing them in a medium including a solvent and a binder, suitable in particular for the manufacture of an electrode, without having recourse to a stage comprising the grinding of the carbon-based conductive fillers (in particular in a bead mill or by pulverization), subjecting them to ultrasound or passing them through a rotor-stator system and without using a surfactant.

### DETAILED DESCRIPTION

The constituents employed in the first stage of the process according to the invention will now be described in more detail.

### Carbon-Based Conductive Fillers

In the continuation of this description, for the purposes of simplicity, the term “carbon-based conductive filler” denotes a filler comprising at least one component from the group formed of carbon nanotubes and nanofibers and carbon black, and graphene, or a mixture of these in all proportions.

The carbon nanotubes can be of the single-walled, double-walled or multi-walled type. The double-walled nanotubes can in particular be prepared as described by Flahaut et al. in Chem. Com. (2003), 1442. The multi-walled nanotubes for their part can be prepared as described in the document WO 03/02456. Preference is given, according to the invention, to the multi-walled carbon nanotubes obtained according to a chemical vapor deposition (or CVD) process, by catalytic decomposition of a source of carbon (preferably of vegetable origin), as described in particular in the application EP 1 980 530 of the applicant company.

The nanotubes usually have a mean diameter ranging from 0.1 to 100 nm, preferably from 0.4 to 50 nm and better still from 1 to 30 nm, indeed even from 10 to 15 nm, and advantageously a length of 0.1 to 10 μm. Their length/diameter ratio is preferably greater than 10 and generally greater than 100. Their specific surface is, for example, between 100 and 300 m²/g, advantageously between 200 and 300 m²/g, and their apparent density can in particular be between 0.05 and 0.5 g/cm³ and more preferably between 0.1 and 0.2 g/cm³. The multi-walled nanotubes can, for example, comprise from 5 to 15 sheets (or walls) and more preferably from 7 to 10 sheets. These nanotubes may or may not be treated.

An example of crude carbon nanotubes is commercially available in particular from Arkema under the trade name Graphistrength® C100.

These nanotubes can be purified and/or treated (for example oxidized) and/or functionalized, before they are employed in the process according to the invention.

The nanotubes can be purified by washing using a sulfuric acid solution, so as to free them from possible residual inorganic and metallic impurities, such as, for example, iron, originating from their preparation process. The weight ratio of the nanotubes to the sulfuric acid can in particular be between 1:2 and 1:3. The purification operation can furthermore be carried out at a temperature ranging from 90° C. to 120° C., for example for a period of time of 5 to 10 hours. This operation can advantageously be followed by stages in which the purified nanotubes are rinsed with water and dried. In an alternative form, the nanotubes can be purified by high-temperature heat treatment, typically at greater than 1000° C.

The oxidation of the nanotubes is advantageously carried out by bringing the latter into contact with a sodium hypochlorite solution including from 0.5% to 15% by weight of NaOCl and preferably from 1% to 10% by weight of NaOCl, for example in a weight ratio of the nanotubes to the sodium hypochlorite ranging from 1:0.1 to 1:1. The oxidation is advantageously carried out at a temperature of less than 60° C. and preferably at ambient temperature, for a period of time ranging from a few minutes to 24 hours. This oxidation operation can advantageously be followed by stages in which the oxidized nanotubes are filtered and/or centrifuged, washed and dried.

The functionalization of the nanotubes can be carried out by grafting reactive units, such as vinyl monomers, to the surface of the nanotubes. The constituent material of the nanotubes is used as radical polymerization initiator after having been subjected to the heat treatment at more than 900° C., in an anhydrous medium devoid of oxygen, which is intended to remove the oxygen-comprising groups from its surface. It is thus possible to polymerize methyl methacrylate or hydroxyethyl methacrylate at the surface of carbon nanotubes for the purpose of facilitating in particular their dispersion in PVDF.

Use may be made, in the present invention, of crude nanotubes, that is to say nanotubes which are neither oxidized nor purified nor functionalized and which have not been subjected to any other chemical and/or heat treatment. In an alternative form, use may be made of purified nanotubes, in particular purified by high-temperature heat treatment. Furthermore, it is preferable for the carbon nanotubes not to be ground.

The carbon nanofibers are, like the carbon nanotubes, nanofilaments produced by chemical vapor deposition (or CVD) starting from a carbon-based source which is decomposed on a catalyst comprising a transition metal (Fe, Ni, Co, Cu), in the presence of hydrogen, at temperatures of 500° C. to 1200° C. However, these two carbon-based fillers differ in their structure (I. Martin-Gullon et al., Carbon 44 (2006), 1572-1580). This is because the carbon nanotubes are composed of one or more graphene layers wound concentrically around the axis of the fiber to form a cylinder having a diameter of 10 to 100 nm. On the contrary, the carbon nanofibers are composed of more or less organized graphite regions (or turbostratic stacks), the planes of which are inclined at variable angles with respect to the axis of the fiber. These stacks can take the form of platelets, fishbones or dishes stacked in order to form structures having a diameter generally ranging from 100 nm to 500 nm, indeed even more. Furthermore, carbon black is a colloidal carbon-based material manufactured industrially by incomplete combustion of heavy petroleum products, which is provided in the form of carbon spheres or of aggregates of these spheres, the dimensions of which are generally between 10 and 1000 nm.

It is preferable to use carbon nanofibers having a diameter of 100 to 200 nm, for example of approximately 150 nm (VGCF® from Showa Denko), and advantageously a length of 100 to 200 μm.

The term “graphene” denotes a flat, isolated and separate graphite sheet but also, by extension, an assemblage comprising between one and a few tens of sheets and exhibiting a flat or more or less wavy structure. This definition thus encompasses FLGs (Few Layer Graphene) NGPs (Nanosized Graphene Plates), CNSs (Carbon NanoSheets) or GNRs (Graphene NanoRibbons). On the other hand, it excludes carbon nanotubes and nanofibers, which are respectively composed of the winding of one or more graphene sheets coaxially and of the turbostratic stacking of these sheets.

Furthermore, it is preferable for the graphene used according to the invention not to be subjected to an additional stage of chemical oxidation or of functionalization.

The graphene used according to the invention is advantageously obtained by chemical vapor deposition or CVD, preferably according to a process using a pulverulent catalyst based on a mixed oxide. It is characteristically provided in the form of particles having a thickness of less than 50 nm, preferably of less than 15 nm, more preferably of less than 5 nm, and having lateral dimensions of less than a micron, preferably from 10 nm to less than 1000 nm, more preferably from 50 to 600 nm, indeed even from 100 to 400 nm. Each of these particles generally includes from 1 to 50 sheets, preferably from 1 to 20 sheets and more preferably from 1 to 10 sheets, indeed even from 1 to 5 sheets, which are capable of being separated from one another in the form of independent sheets, for example during a treatment with ultrasound.

According to a preferred embodiment of the invention, the carbon-based conductive fillers comprise carbon nanotubes, preferably multi-walled nanotubes, obtained according to a chemical vapor deposition process, and optionally carbon nanofibers and/or carbon black and/or graphene.

The carbon-based conductive fillers represent from 15% to 40% by weight, preferably from 20% to 35% by weight, with respect to the weight of the masterbatch.

### Polymeric Binder

The polymeric binder used in the present invention is advantageously chosen from the group consisting of polysaccharides, modified polysaccharides, polyethers, polyesters, acrylic polymers, polycarbonates, polyimines, polyamides, polyacrylamides, polyurethanes, polyepoxides, polyphosphazenes, polysulfones, halogenated polymers, natural rubbers, functionalized or nonfunctionalized elastomers, in particular elastomers based on styrene, butadiene and/or isoprene, and their mixtures. These polymeric binders can be used in the solid form or in the solution or liquid dispersion (latex type) form or also in the supercritical solution form.

Preferably, for use in the manufacture of an electrode, the polymeric binder is chosen from the group consisting of halogenated polymers and more preferably still from the fluoropolymers defined in particular in the following way:

(i) those comprising at least 50 mol % of at least one monomer of formula (I):

CFX₁=CX₂X₃ (I)

where X₁, X₂ and X₃ independently denote a hydrogen or halogen (in particular fluorine or chlorine) atom, such as poly(vinylidene fluoride) (PVDF), preferably in the α form, poly(trifluoroethylene) (PVF3), polytetrafluoroethylene (PTFE), copolymers of vinylidene fluoride with either hexafluoropropylene (HFP) or trifluoroethylene (VF3) or tetrafluoroethylene (TFE) or chlorotrifluoroethylene (CTFE), fluoroethylene/propylene (FEP) copolymers, or copolymers of ethylene with either fluoroethylene/propylene (FEP) or tetrafluoroethylene (TFE) or chlorotrifluoroethylene (CTFE);

(ii) those comprising at least 50 mol % of at least one monomer of formula (II):

R—O—CH—CH₂ (II)

where R denotes a perhalogenated (in particular perfluorinated) alkyl radical, such as perfluoropropyl vinyl ether (PPVE), perfluoroethyl vinyl ether (PEVE) and copolymers of ethylene with perfluoromethyl vinyl ether (PMVE),

preferably PVDF.

When it is intended to be incorporated in formulations in an aqueous medium, the masterbatch according to the invention advantageously includes, as binder, at least one modified polysaccharide, such as a modified cellulose, in particular carboxymethylcellulose. This modified polysaccharide can be provided in the form of an aqueous solution or in the solid form or also in the form of a liquid dispersion.

The polymeric binder can represent from 1% to 15% by weight, preferably from 2% to 10% by weight, with respect to the weight of the masterbatch. The ratio by weight of the polymeric binder to the carbon-based conductive fillers is between 0.04 and 0.4 and it is furthermore preferable for it to be between 0.05 and 0.12, limits included.

### Polymeric Dispersant

The polymeric dispersant used in the masterbatch prepared according to the invention is a polymer chosen from poly(vinylpyrrolidone) or PVP, poly(phenylacetylene) or PAA, poly(meta-phenylene vinylidene) or PmPV, polypyrrole or PPy, poly(para-phenylene benzobisoxazole) or PBO, poly(vinyl alcohol) or PVA, and their mixtures. It is preferable to use PVP.

The polymeric dispersant can represent from 1% to 40% by weight, preferably from 2% to 10% by weight, with respect to the weight of the masterbatch. The ratio by weight of the polymeric dispersant to the carbon-based conductive fillers is between 0.1 and 1, limits included, and it is preferable furthermore for it to be between 0.25 and 0.8, limits included.

### Solvent

The solvents used in stage (i) and in stage (iii) can be chosen from an organic solvent or water or their mixtures in all proportions. Mention may be made, among organic solvents, of N-methylpyrrolidone (NMP), dimethyl sulfoxide (DMSO), dimethylformamide (DMF), ketones, acetates, furans, alkyl carbonates, alcohols and their mixtures. NMP, DMSO and DMF are preferred for use in the present invention, NMP being particularly preferred.

The amount of solvent present in the masterbatch is between 20% and 85% by weight, more preferably between 50% and 75% by weight and better still between 60% and 75% by weight, limits included, with respect to the total weight of the masterbatch.

Care will be taken, of course, in the choice of the proportions of various constituents described above, to ensure that the combined constituents of the masterbatch represent 100% by weight.

In the first stage of the process according to the invention, the carbon-based conductive fillers, the polymeric binder, the polymeric dispersant and the solvent are introduced and then kneaded in a kneader.

Use is preferably made, as kneader, of a compounding device. Compounding devices are well known to a person skilled in the art and generally comprise feeding means, in particular at least one hopper for the pulverulent materials and/or at least one injection pump for the liquid materials; high-shear kneading means, for example a corotating or counterrotating twin-screw extruder or a co-kneader, usually comprising an endless screw positioned in a heated barrel (tube); an outlet head which gives its shape to the exiting material; and the means for cooling the material, under air or using a water circuit. The material generally occurs in the form of a rod continuously exiting from the device, which rod can be cut up or shaped into granules. However, other forms can be obtained by attaching a die of the desired form to the outlet die.

Examples of co-kneaders which can be used according to the invention are the Buss® MDK 46 co-kneaders and those of the Buss® MKS or MX series, sold by Buss AG, which are all composed of a screw shaft provided with flights which is positioned in a heating barrel optionally composed of several parts, the internal wall of which is provided with kneading teeth appropriate for interacting with the flights to produce shearing of the kneaded material. The shaft is driven in rotation and provided with an oscillating movement in the axial direction by a motor. These co-kneaders can be equipped with a system for manufacturing granules, for example attached to their outlet orifice, which can be composed of an extrusion screw and of a granulation device.

The co-kneaders which can be used according to the invention preferably have a screw ratio L/D ranging from 7 to 22, for example from 10 to 20, advantageously 11, while the corotating extruders advantageously have an L/D ratio ranging from 15 to 56, for example from 20 to 50.

A preferred embodiment of stage (i) consists in carrying out the kneading of the mixture using a corotating or counterrotating twin-screw extruder or more preferably using a co-kneader (in particular of Buss® type) comprising a rotor provided with flights appropriate for interacting with teeth fitted to a stator, said co-kneader advantageously being equipped with an extrusion screw and with a granulation device. The kneading can be carried out at a temperature of between 20° C. and 90° C., preferably between 60° C. and 80° C., limits included.

The constituents of the masterbatch can be introduced separately into the kneader or in the form of premixes of two at least of these constituents. In particular, the powder of the binding polymer can be predissolved in the solvent before introduction into the kneader. In an alternative form, the carbon-based conductive fillers, the polymeric binder and the polymeric dispersant can be introduced separately, or in premix form, into the feed hopper of the co-kneader, while the solvent is injected in liquid form into the first zone of the co-kneader.

On conclusion of this stage, the masterbatch is extruded in solid form and then optionally cut up, in particular in the form of granules. A stage of forming granules starting from the masterbatch can thus be provided between stages (ii) and (iii) of the process according to the invention.

The masterbatch is subsequently diluted in a solvent identical to or different from that of stage (i) in order to obtain a pasty composition. This stage (iii) can preferably be carried out in a kneader, such as that used in stage (i), or, in an alternative form, in another mixing device, such as a deflocculator. The degree of dilution in stage (iii), that is to say the ratio by weight of the solvent to the masterbatch, can be between 2:1 and 10:1, preferably between 3:1 and 5:1.

It is clearly understood that the above process can comprise other preliminary, intermediate or subsequent stages, provided that they do not negatively affect the production of the desired pasty composition. It can in particular comprise one or more stages of addition of one or more organic or inorganic additives. However, it is preferable for this process not to comprise any stage of grinding the carbon-based conductive fillers, of subjecting the carbon-based conductive fillers to ultrasound or passing them through a rotor-stator device, and/or an addition of surfactant(s)

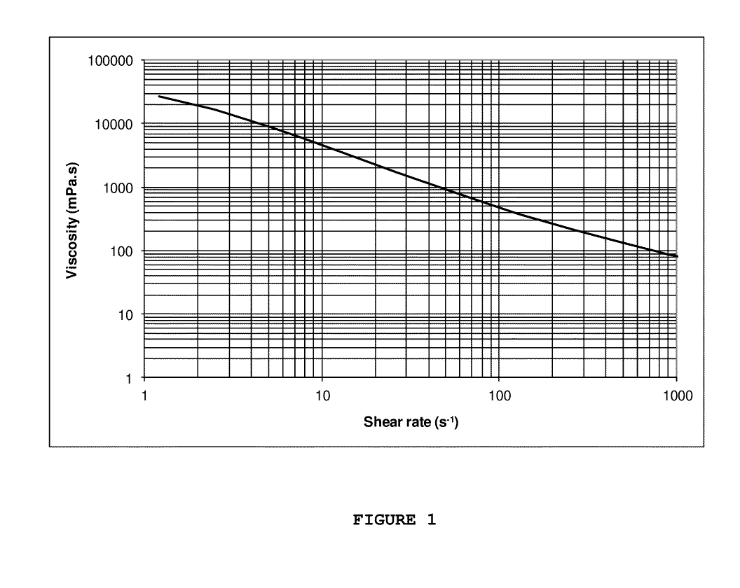

The pasty composition thus obtained exhibits a more or less high viscosity according to the applications envisaged, ranging from the consistency of a liquid to that of a paste of tar type. They can thus be between 200 and 1000 mPa·s, for example between approximately 400 and 600 mPa·s, as measured using a Rheomat RM100 model Lamy viscometer provided with a DIN22 measurement system and controlled by VISCO-ROM Soft Lamy acquisition software, according to the following protocol: 20 ml of paste are introduced into the measurement cylinder, which is subsequently assembled with the rotor on the apparatus. The viscosity curve is then plotted, the gradient being varied between 1.2 and 1032 s⁻¹ at a temperature of 23° C., and then the viscosity corresponding to a gradient of 100 s⁻¹ is read (see FIG. 1).

This pasty composition differs in particular from a solid in so far as it is impossible to measure its Young's modulus at ambient temperature and in so far as its softening point is below ambient temperature.

The pasty composition obtained according to the invention advantageously includes from 0.5% to 20% by weight, preferably from 1% to 15% by weight and better still from 4% to 7% by weight of carbon-based conductive fillers.

It can be used in various applications as is or after dilution in a solvent, such as that employed in stage (i) and/or (iii). This paste can in particular be used in the preparation of thin conductive films, conductive inks or conductive coatings, in particular in the manufacture of electrodes of Li-ion batteries or of supercapacitors; or in the preparation of conductive composite materials by introducing it, for example, into a polyurethane-based polymer matrix; or also in the manufacture of paints, lubricants or textiles.

The process for the preparation of an electrode from the pasty composition according to the invention can comprise the following stages:
a) the preparation of a solution by dissolution of at least one first polymeric binder in at least one first solvent;
b) optionally, the addition of an electrode active material to said solution;
c) the mixing of the product resulting from stage b) with the pasty composition according to the invention including a second polymeric binder, a second solvent and optionally a third solvent, optionally diluted in a dilution solvent, in order to form a coating composition;
d) optionally, the addition of an electrode active material to the product of stage c);
e) the deposition of said coating composition on a substrate in order to form a film;
f) the drying of said film,
one at least of stages (b) and (d) being included.

In this process, the second solvent denotes that used in the manufacture of the masterbatch and the third solvent denotes the solvent used to manufacture the pasty composition starting from the masterbatch. It is understood that the first, second and third solvents, and also the dilution solvent, can be identical to or different from one another and can be chosen from the abovementioned list. It is preferable for them to be all identical. Likewise, the first binder can be identical to the second binder or different from the latter. It is also preferable for them to be identical.

In this process, stirrers of “flocculator” type are preferred for the implementation of stage (a). In stages (b) and (d), the electrode active material can be dispersed with stirring in the powder form in the mixture resulting from stage (a) or (c), respectively.

This electrode active material can be chosen from the group consisting of:

i) transition metal oxides having a spinel structure of LiM₂O₄ type, where M represents a metal atom comprising at least one of the metal atoms selected from the group formed by Mn, Fe, Co, Ni, Cu, Mg, Zn, V, Ca, Sr, Ba, Ti, Al, Si, B and Mo, said oxides preferably comprising at least one Mn and/or Ni atom;

ii) transition metal oxides having a lamellar structure of LiMO₂ type, where M represents a metal atom comprising at least one of the metal atoms selected from the group formed by Mn, Fe, Co, Ni, Cu, Mg, Zn, V, Ca, Sr, Ba, Ti, Al, Si, B and Mo, said oxides preferably comprising at least one of the atoms selected from the group formed by Mn, Co and Ni;

iii) oxides having polyanionic frameworks of LiM_{y}(XO_{z}), type, where:
M represents a metal atom comprising at least one of the metal atoms selected from the group formed by Mn, Fe, Co, Ni, Cu, Mg, Zn, V, Ca, Sr, Ba, Ti, Al, Si, B and Mo, and
X represents one of the atoms selected from the group formed by P, Si, Ge, S and As,

preferably LiFePO₄,

iv) vanadium-based oxides,

v) graphite,

vi) titanates.

The electrode active materials i) to iv) are more suited as preparation of cathodes and are preferred according to the invention, whereas the electrode active materials v) and vi) are more suited to the preparation of anodes.

The dispersion of the first binder is mixed with the pasty composition according to the invention in stage (c). This mixing can be carried out using any mechanical means, provided that they make it possible to obtain a homogeneous dispersion. It is preferable according to the invention for the mixing of stage c) to be carried out using a mixer of “flocculator” type.

During stage (e), the film obtained from the suspension resulting from stage (c) or (d) can be deposited on a substrate by any conventional means, for example by extrusion, by tape casting, by coating or by spray drying, followed by a stage of drying (stage (f)).

The substrate can in particular be a current collector. An electrode is thus obtained.

The proportions of the various compounds used in the above process are adjusted so that the film obtained advantageously includes from 1% to 2% by weight of carbon-based conductive fillers.

By virtue of the process according to the invention, it is in particular possible to distribute the carbon nanotubes in such a way that they form a meshwork around the particles of active material and thus play a role both of conductive additive and also of mechanical maintenance, which is important in order to accommodate the variations in the volume during the charging/discharging stages. On the one hand, they provide for the delivery of the electrons to the active material particles and, on the other hand, due to their length and their flexibility, they form electrical bridges between the active material particles which move about as a result of their variation in volume. When they are used alone, the usual conductive additives (SP carbon, acetylene black and graphite), with their relatively low aspect ratio, are less effective in providing for the maintenance during the cycling of the transportation of the electrons from the current collector. This is because, with conductive additives of this type, the electrical pathways are formed by the juxtaposition of grains and the contacts between them are easily broken as a result of the expansion in volume of the particles of the active material.

The invention will now be illustrated by the following examples, which do not have the aim of limiting the scope of the invention, defined by the claims. In these examples, reference is made to the appended figures, in which:

FIG. 1 illustrates the curve of viscosity of a paste according to the invention as a function of the shearing,

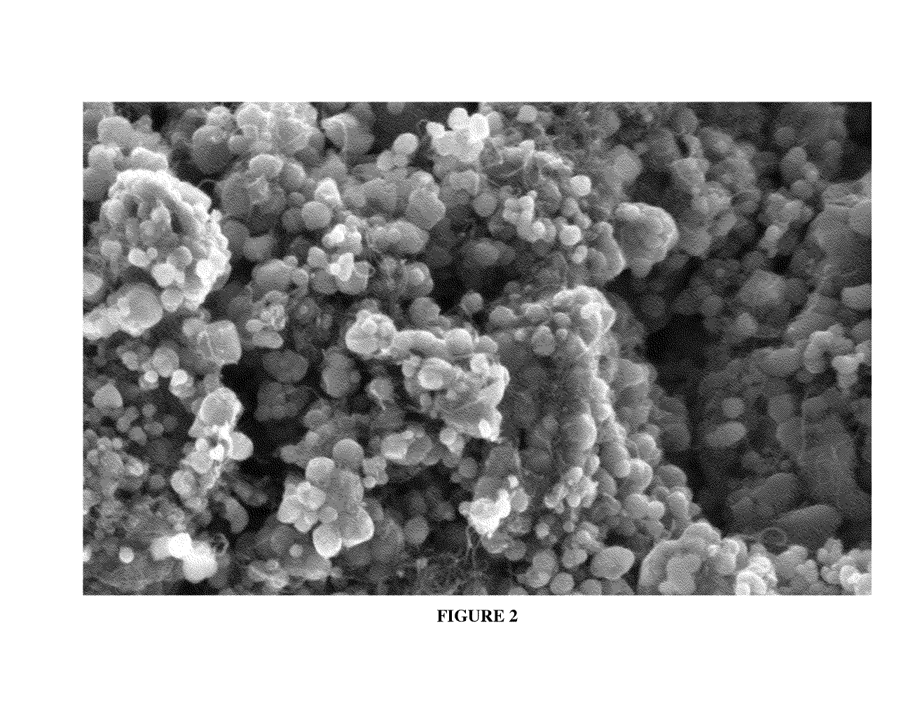

FIG. 2 is an SEM photograph (magnification: 50 000 times) showing the dispersion of the CNTs, obtained from the paste according to the invention, around LiFePO₄/C particles,

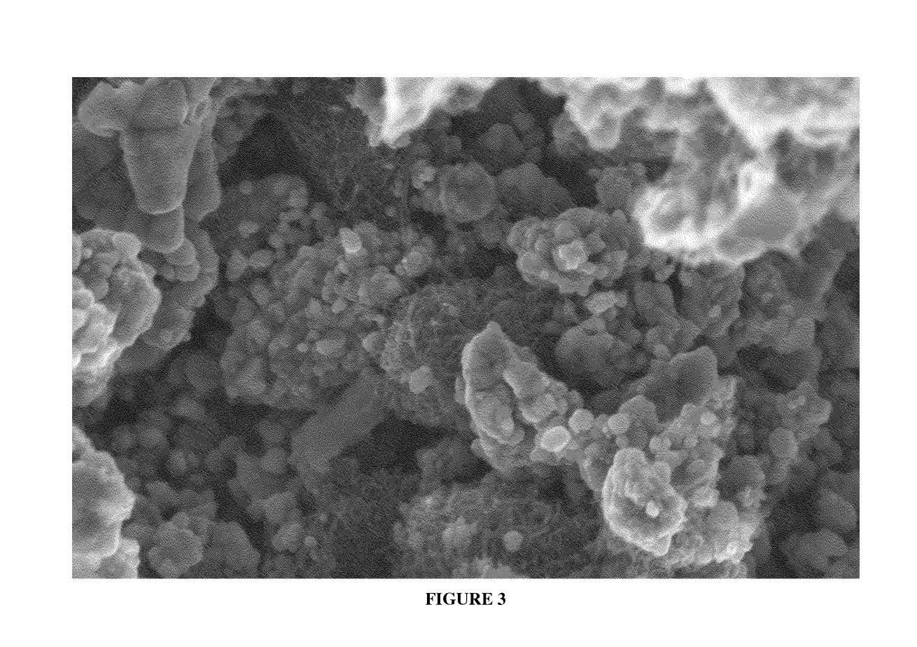

FIG. 3 is an SEM photograph (magnification: 50 000 times) showing the dispersion of the CNTs, obtained from a paste devoid of dispersant, around LiFePO₄/C particles, and

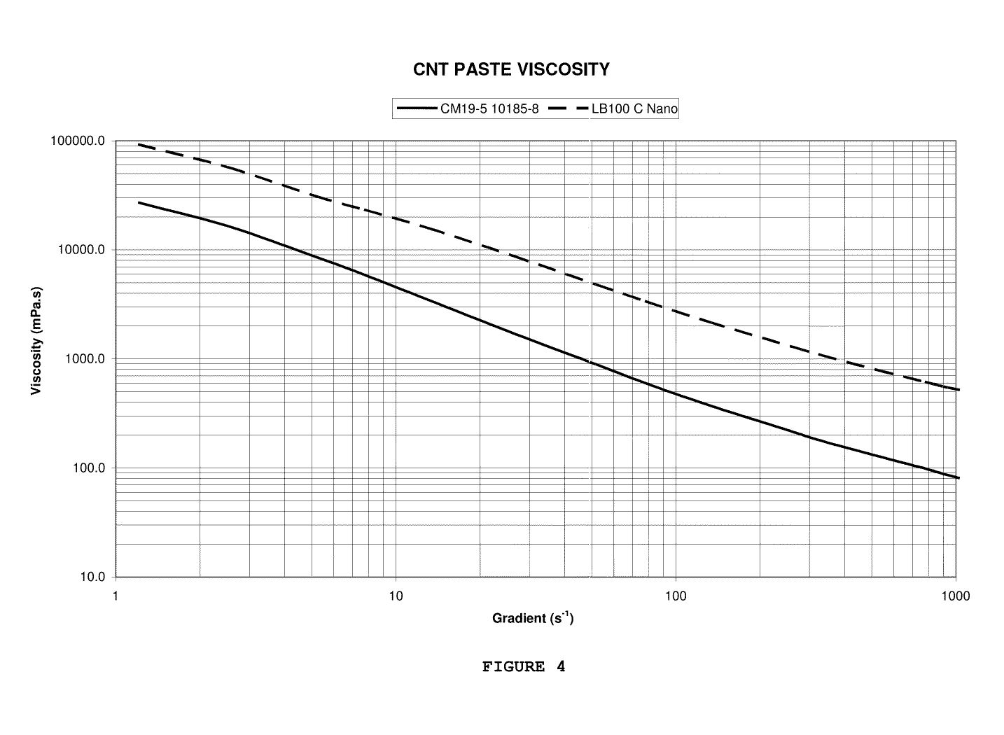

FIG. 4 illustrates the curves of viscosity of a paste according to the invention and of a commercial paste, as a function of the shearing.

### EXAMPLES

### Example 1

### Manufacture of a Pasty Composition According to the Invention

CNTs (Graphistrength® C100 from Arkema) were introduced into the first feed hopper of a Buss® MDK 46 co-kneader (L/D=11), equipped with a recovery extrusion screw and with a granulation device. Poly(vinylidene fluoride) (PVDF) (Kynar® HSV 900 from Arkema) and poly(vinylpyrrolidone) (PVP) were metered into the same hopper in the powder form. N-Methylpyrrolidone (NMP) was injected in liquid form at 50° C. into the 1st zone of the co-kneader. The set temperature values and the flow rate within the co-kneader were as follows: Zone 1: 80° C., Zone 2: 80° C., Screw: 60° C., Flow rate: 15 kg/h.

A solid masterbatch including: 25% by weight of CNTs, 2% by weight of PVDF, 7% by weight of PVP and 66% by weight of NMP was obtained in the outlet of the co-kneader.

The granules were cut up under dry conditions at the outlet of the die.

The granules were introduced into the first zone of the co-kneader and the additional NMP was injected into the same zone, in a proportion of 80% by weight of NMP for 20% by weight of granules. The temperature profile and the flow rate were unchanged. An homogeneous paste was obtained at the outlet of the recovery extruder and was collected directly in metal kegs.

The paste had the following composition: 5% by weight of CNTs, 0.4% by weight of PVDF, 1.4% by weight of PVP and 93.2% by weight of NMP.

After storing for 2 months, neither a change in the viscosity nor a phenomenon of phase separation (no presence of supernatant liquid) was observed.

The carbon nanotubes of this paste were observed:
on the one hand, with a scanning electron microscope (SEM) after dilution (×10) of the paste, followed by evaporation of the NMP, and
on the other hand, by particle size analysis, using a Malvern particle sizer, after strongly diluting (×100 000) the paste.

These observations have shown that the carbon nanotubes were well dispersed and that they formed aggregates of 3 to 10 μm mixed with individual nanotubes having a length of between 0.2 and 1 μm.

### Example 2

### Use of a Pasty Composition in the Manufacture of an Electrode

Stage a)

A pasty composition as described in example 1 was prepared, except that it contained 5% by weight of CNTs, 1% by weight of PVP, 0.8% by weight of PVDF and 93.2% by weight of NMP. 40 g of this composition were poured into 85.6 g of NMP and mixed using a deflocculating stirrer with a diameter of 50 mm at 850 rev/min for 1 h. The solution obtained was denoted by “CNT premix”.

Stage b)

A 12% solution of PVDF (Kynar® HSV 900 from Arkema) in NMP was prepared using a stirrer of flocculator type at 50° C. for 4 hours.

Stage c)

30.9 g of the PVDF solution were dispersed in the “CNT premix” at 1100 rev/min for 5 minutes.

Stage d)

93.6 g of LiFePO₄/C (LFP) powder (2B grade from Prayon) were gradually dispersed in the preceding dispersion while maintaining the stirring rate at 1100 rev/min. The increase in viscosity of the medium subsequently made it possible to increase the stirring rate to up to 1700 rev/min. This stirring rate was maintained for one hour.

The composition of the ink on a dry basis was as follows: 2% by weight of CNTs; 4% by weight of PVDF, 0.4% by weight of PVP and 93.6% by weight of LiFePO₄/C, with a solids content of 40% in the NMP solvent.

Stage e)

A film with a thickness of 200 μm was produced on a 25 μm aluminum foil using a Sheen-type film applicator and an adjustable BYK-Gardner® applicator.

Stage f)

The film produced during stage e) was dried at 55° C. for 4 h in a ventilated oven and then compressed under 200 bar in order to obtain a final active material thickness of approximately 60 μm.

Observations with an SEM (see FIG. 2) showed that the CNTs are well dispersed around the micrometric LiFePO₄/C particles. Furthermore, the electrical conductivity of the electrode obtained is equal to 2.8 μS/cm.

### Example 3 (Comparative)

### Analysis of a Dispersant-Free CNT Paste

Starting from a paste prepared as described in example 1 but not including PVP, a film including 2% by weight of CNTs, 4% by weight of PVDF and 94% by weight of LiFePO₄/C with a solids content of 40% in NMP was prepared in accordance with the process described in example 2.

This film was observed with an SEM. As emerges from FIG. 3, the CNTs exist in the form of nondisperse aggregates around the micrometric LiFePO₄/C particles, which is reflected by a significant decrease in the electrical conductivity, which becomes established at 0.05 μS/cm, with respect to that measured in example 2.

It is thus apparent that the PVP, although used in a small amount in example 2, contributes markedly to the good dispersion of the CNTs. In addition, it makes it possible to obtain a better conductivity.

### Example 4 (Comparative)

### Analysis of a Commercial CNT Paste

The CNT paste sold by C Nano under the trade name LB100® was compared with a paste prepared according to the process in accordance with the invention, as described in example 1. According to the technical sheet, the product LB100 comprises from 1% to 5% of CNTs, from 0.2% to 1.25% of dispersant and from 93% to 98% of NMP.

In order to do this, the two pastes were subjected to a viscosity measurement using a Rheomat RM100 model Lamy viscometer provided with a DIN22 measurement system and controlled by VISCO-RM Soft Lamy acquisition software, according to the following protocol: 20 ml of paste are introduced into the measurement cylinder, which is subsequently assembled with the rotor on the apparatus. A viscosity curve is then plotted, the gradient being varied between 1.2 and 1032 s⁻¹ at a temperature of 23° C.

As emerges from FIG. 4, at a shear rate of 100 s⁻¹, the viscosity of the paste according to the invention is approximately 500 mPa·s, whereas it is approximately 3000 mPa·s for the commercial paste.

It is thus apparent that the paste obtained according to the process according to the invention is more fluid and thus easier to handle than the commercial paste.

1. A process for the preparation of a pasty composition based on carbon-based conductive fillers, comprising:
(i) the introduction into a kneader, and then the kneading, of carbon-based conductive fillers, of at least one polymeric binder, of at least one solvent and of at least one polymeric dispersant distinct from said binder, chosen from poly(vinylpyrrolidone), poly(phenylacetylene), poly(meta-phenylene vinylidene), polypyrrole, poly(para-phenylene benzobisoxazole), poly(vinyl alcohol) and their mixtures, in order to form a masterbatch comprising a proportion by weight of 15% to 40% of carbon-based conductive fillers and of 20% to 85% of solvent and in which the ratio by weight of the polymeric binder to the carbon-based conductive fillers is between 0.04 and 0.4 and the ratio by weight of the polymeric dispersant to the carbon-based conductive fillers is between 0.1 and 1, limits included;
(ii) the extrusion of said masterbatch in a solid form;
(iii) the diluting of said masterbatch in a solvent which is identical to or different from that of stage (i), in order to obtain a pasty composition.

2. The process as claimed in claim 1, wherein the carbon-based conductive fillers comprise carbon nanotubes, carbon nanofibers, carbon black or graphene, or a mixture of these in any proportions.

3. The process as claimed in claim 1, wherein said polymeric binder is chosen from the group consisting of polysaccharides, modified polysaccharides, polyethers, polyesters, acrylic polymers, polycarbonates, polyimines, polyamides, polyacrylamides, polyurethanes, polyepoxides, polyphosphazenes, polysulfones, halogenated polymers, natural rubbers, functionalized or nonfunctionalized elastomers, and their mixtures.

4. The process as claimed in claim 3, wherein the polymeric binder is chosen from the group consisting of the following fluoropolymers:
(i) those comprising at least 50 mol % of at least one monomer of formula (I):
CFX₁=CX₂X₃ (I)
where X₁, X₂ and X₃ independently denote a hydrogen or halogen atom; and
(ii) those comprising at least 50 mol % of at least one monomer of formula (II):
R—O—CH—CH₂ (II)
where R denotes a perhalogenated alkyl radical.

5. The process as claimed in claim 1, wherein said solvent is N-methylpyrrolidone, dimethyl sulfoxide or dimethylformamide.

6. The process as claimed in claim 1, wherein the polymeric dispersant is poly(vinylpyrrolidone).

7. The process as claimed in claim 1, wherein the kneader is a compounding device chosen from a corotating or counterrotating twin-screw extruder and a co-kneader comprising a rotor provided with flights appropriate for interacting with teeth fitted to a stator.

8. The process as claimed in claim 1, wherein a stage of forming granules starting from the masterbatch is additionally included between stages (ii) and (iii).

9. The process as claimed in claim 1, wherein stage (iii) is carried out in a kneader.

10. The process as claimed in claim 1, wherein the degree of dilution in stage (iii) is between 2:1 and 10:1.

11. A pasty composition obtained according to the process as claimed in claim 1, wherein the composition has a viscosity of between 200 and 1000 mPa·s.

12. A conductive composition comprising the pasty composition as claimed in claim 11, wherein the conductive composition is in the form of thin conductive films, conductive inks or conductive coatings.
